(19) United States
(12) Patent Application Publication
(10) Pub. No.: US 2012/0057235 A1
(43) Pub. Date: Mar. 8, 2012

(54) Method for Antireflection in Binary and Multi-Level Diffractive Elements

(75) Inventors: Chih-Hao Chang, Raleigh, NC (US); Jose A. Dominguez-Caballero, Portland, OR (US); George Barbastathis, Boston, MA (US)

(73) Assignee: MASSACHUSETTS INSTITUTE OF TECHNOLOGY, Cambridge, MA (US)

(21) Appl. No.: 13/224,472

(22) Filed: Sep. 2, 2011

Related U.S. Application Data
(60) Provisional application No. 61/379,804, filed on Sep. 3, 2010.

(51) Int. Cl. G02B 27/42

(52) U.S. Cl. 359/558

(57) ABSTRACT

Methods and apparatus for reducing or eliminating reflection at the interface between a binary or multi-level diffractive element and a surrounding medium. A non-planar diffractive surface of a diffractive optical element is coated forming a plurality of nanostructures on the non-planar diffractive surface and, in certain embodiments, on a planar surface as well. The nanostructures are chosen for providing adiabatic refractive index matching at the optical interface between the non-planar diffractive surface and a surrounding medium subject to matching tangential fields at surface discontinuities.

The present application claims priority from U.S. Provisional Patent Application Ser. No. 61/379,804, filed Sep. 3, 2010, which application is incorporated herein by reference.

### TECHNICAL FIELD

The present invention relates to minimizing reflective losses by antireflective treatment of optical surfaces with subwavelength structures, and, more particularly, for antireflective (AR) treatment of surfaces of binary and multi-level diffractive optical elements.

### BACKGROUND ART

Traditional diffractive optical elements (DOEs), such as gratings, Fresnel lenses, and computer generated holograms, have both transmitted and reflected diffraction orders as a result of refractive index mismatch between the material of the DOE (e.g., glass) and the surrounding medium (e.g., air). When operating in transmission mode, a portion of the light is reflected at every interface between the diffractive optical element and the surrounding medium, resulting in a loss of energy of the transmitted field. The fraction of reflected and transmitted power depends upon the angle of incidence of the incident wave, and on the ratio of the refractive indices before and after the interface, as described by coupled mode theory, as discussed in Yariv et al., Optical Waves in Crystals (Wiley, 1984), which reference is incorporated herein in its entirety by reference.

For applications such as solar concentration, optical ablation, and lithography, the energy loss due to refractive index mismatch has a severe impact on overall system performance. A method for minimizing these losses is therefore of utmost importance. One example of an application impacted by refractive index mismatch loss is that of integrated solar concentrators where a polychromatic element is used for concentrating and spectral-splitting the incident solar irradiance, as described in US Published Patent Application No. 2010-0095999, to Menon (hereinafter, the “Menon '999 Application”), entitled Ultra-High Efficiency Multi-Junction Solar Cells Using Polychromatic Diffractive Concentrators, filed Oct. 17, 2008, and incorporated herein by reference.

Definition: As used herein, and in any appended claim, the term “polychromat” shall refer to a solid medium characterized by a structured surface or inhomogeneous index of refraction, giving rise to a multiple-wavelength diffractive optic that is non-periodic and lacks rotational symmetry. The diffractive optic may be a binary or multi-level phase optic in certain embodiments, however the invention is not so limited. Examples of polychromats and teachings related to their design and fabrication may be found in US Published Application 2010-0097703 (Menon, hereinafter, the “Menon '703 Application”), and in Dominguez-Caballero, “Design and Optimization of the Holographic Process for Imaging and Lithography,” Ph.D. Thesis, Massachusetts Institute of Technology, February, 2010, available at http://mit.edu/jadc/Public/PhD%20thesis/ (hereinafter, the “Dominguez-Caballero Thesis”, both of which documents are incorporated herein by reference.

In a solar concentrator such as described in the Menon '999 Application, a portion of the incident sunlight will be reflected back at every interface within the polychromat and will not reach the corresponding solar cell. This results in module efficiency losses, reducing the amount of power produced by the solar module.

Other examples of applications severely degraded by reflections are those of ablation and lithography where Fresnel lenses or computer-generated holograms are used to project incident light to form a desired ablation pattern or image at a parallel plane where an ablation substrate, or photoresist to be exposed, is placed. Such applications are described in the Dominguez-Caballero Thesis, and in Dominguez-Caballero et al., Design and sensitivity analysis of Fresnel domain computer generated holograms, Int. J. Nanomanufacturing, vol. 6, pp. 207-18 (2010), and in US Published Patent Application Serial No. 2011/0042588 (to Dominguez-Caballero et al.), all of which are incorporated herein by reference. In these application as well, reflection losses reduce the amount of energy transmitted through the system and therefore require more powerful and expensive laser sources.

A final example is in optical communications in which grating couplers are used to convert an out-of-plane free-space beam to an in-plane guided beam in a waveguide. A maximum coupling efficiency would require optimizing the diffraction efficiency of each grating coupler and minimizing the Fresnel reflections at the dielectric-air interface.

Bio-inspired subwavelength gradient index structures have been proposed for plane surfaces, along lines described by Vukusic et al., Photonic structures in biology, Nature, vol. 424, pp. 852-55 (2003), which is incorporated herein by reference. In such structures, the refractive index of the surface is engineered in a way so that it varies gradually between the material/air interface. The resulting gradient index surface effectively reduces reflection, allowing more light to propagate into the material unimpeded. In recent years researchers have adapted this principle to suppress a single reflection from a flat surface, as described in Kanamori et al., Broadband antireflection gratings fabricated upon silicon substrates, Opt. Lett., vol. 24, pp. 1422-24 (1999). Boufarron et al., Enhanced antireflecting properties of micro-structured top-flat pyramids, Opt. Express vol. 16, pp. 19304-09 (2008), and references cited therein, using rigorous diffraction theory to explore the effects of parameters, such as period, depth and shape, on minimizing the reflectance of surfaces with subwavelength structures to minimize reflectance. The foregoing references are incorporated herein by reference.

Analyses and methods applied to the antireflection treatment of plane surfaces are totally unsuitable for application to binary diffractive elements as well as to multi-level diffractive elements. The reason is that rigorous diffraction theory applied to calculation of reflected light assumes a substrate of infinite extent, whereas binary and multi-level diffractive elements, defined below, comprise, of their essence, structures of truncated extent in at least one dimension parallel to the local surface of a substrate. Whereas rigorous calculation of fields at planar surfaces apply boundary conditions of continuity of electric and magnetic field components transverse to the interface, such boundary conditions are insufficient for complex substrate structures as implicated by binary or multi-level diffractive elements.

### SUMMARY OF EMBODIMENTS OF THE INVENTION

Accordingly, embodiments of the present invention teach a novel method for reducing or eliminating reflection at the interface between a binary or multi-level diffractive element and a surrounding medium. The novel method consists of coating a non-planar diffractive surface of the diffractive optical element such that a plurality of nanostructures are formed on the non-planar diffractive surface, wherein the nanostructures are chosen for providing adiabatic refractive index matching at the optical interface between the non-planar diffractive surface and a surrounding medium subject to matching tangential fields at surface discontinuities.

In accordance with further embodiments of the present invention, each nanostructure has a tapered shape in a direction towards the surrounding medium. The plurality of nanostructures have feature sizes smaller than the operating light wavelength. The plurality of nanostructures may be formed in a periodic arrangement or a random arrangement on the non-planar diffractive surface.

In accordance with yet further embodiments of the present invention, nanostructures may further be provided on a flat surface of the diffractive optical element opposite the non-planar diffractive surface.

In accordance with an alternate embodiment of the present invention, at least one of a binary and multi-level diffractive optical element is provided. The diffractive optical element has a plurality of nanostructures formed on a non-planar diffractive surface, wherein characteristics of the plurality of nanostructures are chosen for providing adiabatic refractive index matching at the optical interface between the non-planar diffractive surface and a surrounding medium, subject to matching tangential fields at surface discontinuities.

### BRIEF DESCRIPTION OF THE DRAWINGS

The foregoing features of the invention will be more readily understood from the following detailed description, considered with reference to the accompanying drawings, in which:

FIG. 1(a) is a schematic diagram of a prior art binary diffraction grating, with undesirable reflection orders originating from the abrupt refractive index mismatch at the dielectric-air interface; FIG. 1(b) is a binary diffraction grating with antireflection nanostructure according to the present invention: undesirable reflection orders are suppressed by smoothing the refractive index transition (by adiabatic index matching), in accordance with embodiments of the present invention.

FIG. 2(a) schematically depicts an electric field propagating through, and reflected from, a regular binary grating, with light is incident from the top. FIG. 2(b) shows the behavior of an electric field for a binary grating coated with an antireflection structure in accordance with an embodiment of the present invention.

FIG. 3 depicts antireflection structures coated on both sides (diffractive and flat sides) of a multi-level transmission grating, in accordance with an embodiment of the present invention.

FIG. 4 shows a comparison of the diffraction efficiencies for the same quantized multi-level blazed grating with and without the antireflection nanostructures in accordance with an embodiment of the present invention.

FIG. 5 shows a comparison of the diffraction efficiency of the reflected orders with and without subwavelength nanostructures in accordance with an embodiment of the present invention.

FIG. 6(a) depicts a diffractive element in accordance with an embodiment of the present invention guiding broadband light horizontally to multiple-junction photovoltaic (PV) cells on the walls of a solar device. FIG. 6(b) depicts a diffractive element in accordance with an embodiment of the present invention focusing different wavelengths of light to their corresponding PV cells with matching energy band-gap for efficient energy conversion.

### DETAILED DESCRIPTION OF SPECIFIC EMBODIMENTS

Definitions. As used in this description and the accompanying claims, the following term shall have the meanings indicated, unless the context otherwise requires:

The term “adiabatic,” as applied to the transition of an index of refraction n(x) from a bulk medium of index n₂ to an ambient medium of index n₁, indicates that for every nε(n₁, n₂) and for every ξ>0, however small, there exists a value δ such that for all |x−x₀|<δ, |n(x)−n(x₀)|<ξ.

The term “binary diffractive element” shall refer to an optical element having the property that a beam having a planar phase front undergoes one of two phase shifts at every position in a plane transverse to the propagation direction of the beam upon transmittal through, or reflection from, the element.

If a planar phase front of an incident beam undergoes a discontinuity at a surface in a direction transverse to the propagation direction of the incident beam, the surface shall be referred to, herein, as “nonplanar.”

The term “multilevel diffractive element” shall refer to a an optical element having the property that a beam having a planar phase front undergoes one of a plurality of phase shifts at every position in a plane transverse to the propagation direction of the beam upon transmittal through, or reflection from, the element. An example is a diffraction grating which, instead of a continuous analog blaze, has quantized stepped surfaces.

In accordance with methods of the present invention, a method is described below for designing antireflection binary and multilevel DOE. A nanostructured antireflection layer is used to suppress some or all undesirable reflections, thereby reducing system losses and increasing the overall efficiency. In the following sections, the description of the invention and some simulation examples are presented.

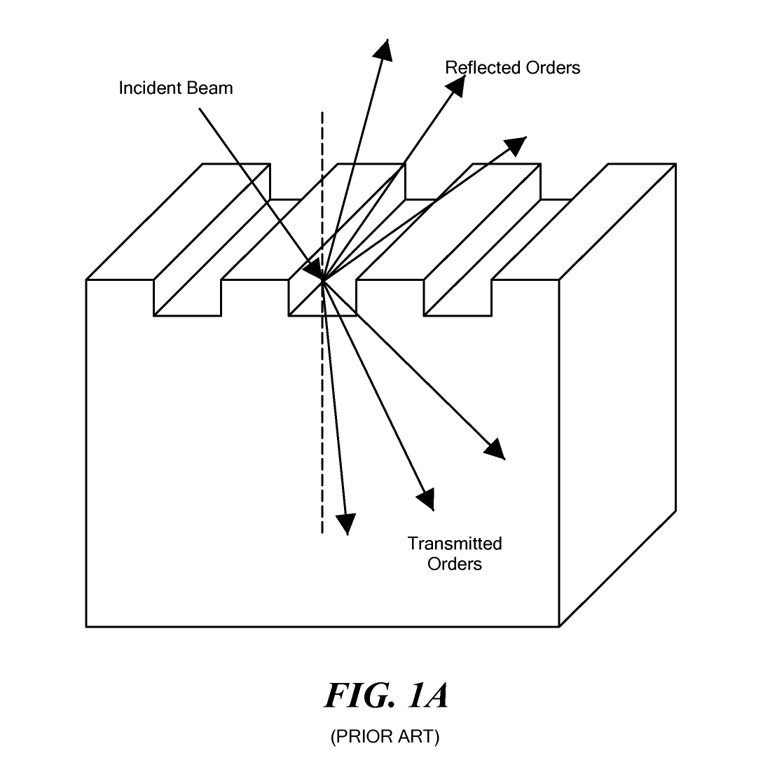

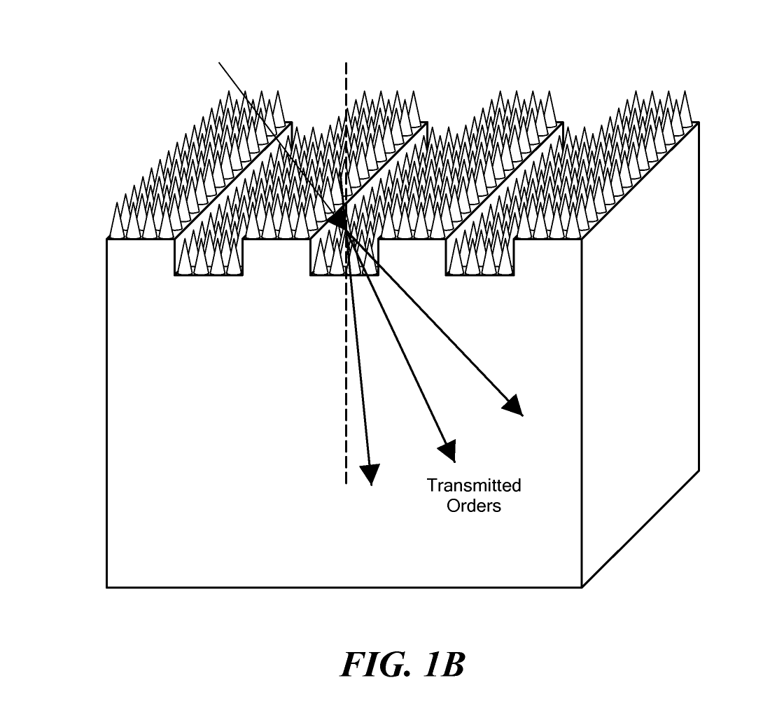

The principle of the disclosed invention and how it can be applied to a diffractive structure is illustrated in FIGS. 1(a) and 1(b). A traditional prior art binary diffraction grating, which diffracts light into transmitted or reflected orders, or both, is depicted in FIG. 1(a). In this configuration, the multiple reflected orders represent Fresnel losses in the system due to refractive index mismatch. The disclosed method for reducing or eliminating reflection consists of patterning subwavelength periodic or random nanostructures on top of the diffractive element, as illustrated in FIG. 1(b). The patterned structures have a nanoscale-tapered shape that allows smoothing the refractive index transition between the surrounding medium and the grating's refractive index; effectively, the tapering constitutes adiabatic index matching between the grating and the surrounding medium. This results in a suppression of the undesirable reflected orders and a significant increase of the transmitted power. The structure therefore reduces loss and improves system efficiency, and can be applied to all types of diffractive structures.

A preferred method for designing subwavelength structures for coating diffractive surfaces so as to provide an adiabatic transition is the rigorous coupled-wave analysis (RCWA), described, for example by Moharam et al., Formulation for stable and efficient implementation of the rigorous coupled-wave analysis of binary gratings, J. Opt. Soc. Am. A, vol. 12, pp. 1068-76 (1995), and Moharam et al., Stable implementation of the rigorous coupled-wave analysis for surface-relief gratings: enhanced transmittance matrix approach, J. Opt. Soc. Am. A, vol. 12, pp. 1077-86 (1995), and Chang et al., Design and optimization of broadband wide-angle antireflection structures for binary diffractive optics, Optics Letters, vol. 35, pp. 907-09 (2010), hereinafter “Chang (2010)”, all of which are incorporated herein by reference. Other methods may also be employed within the scope of the present invention. In one such method, each nanostructure has a tapered shape, narrowing in a direction towards the surrounding medium. Traverse components of electric and magnetic fields in a coupled-wave analysis are matched at surface discontinuities with periodic boundary conditions.

Processes for coating a diffractive surface in accordance with the designs described in the foregoing paragraph include nanolithography, multilayer porous films, self-masking plasma etching, polymer replication, and colloidal assembly. Examples are described in Chang et al., Nanostructured gradient-index antireflection diffractive optics, Optics Lett., vol. 36, pp. 2354-56 (2011), both of which papers are incorporated herein by reference. In one process, in accordance with the present invention, monodispersed polystyrene nanospheres with subwavelength diameter are spincoated onto a silicon substrate with 240 nm hydrogen silsesquioxane (HSQ). The pattern is transferred into HSQ and silicon using methylfluoride and hydrogen bromide reactive ion etching (RIE). The high etch selectivity between silicon and HSQ yields high-aspect-ratio tapered nanostructures. The substrate is then planarized by an antireflection coating layer, and the grating structure is patterned using contact lithography. The planarization polymer is removed and the grating structure etched into the silicon substrate with O₂ and HBr RIE. Other methods may also be employed within the scope of the present invention.

In accordance with embodiments of the present invention, the working principle of the bio-inspired subwavelength gradient index structures is applied for the first time as antireflection nanostructures to binary and multi-level diffractive optics, where prior teachings were applicable only to planar surfaces. The problem posed and solved in this disclosure is significantly more complex than the planar (or locally-planar, such as in the case of curved surfaces) case, since the prior art dealt with a single reflection from a flat surface, whereas, in the present invention, multiple reflected orders are preferably reduced or eliminated.

### Simulation Examples

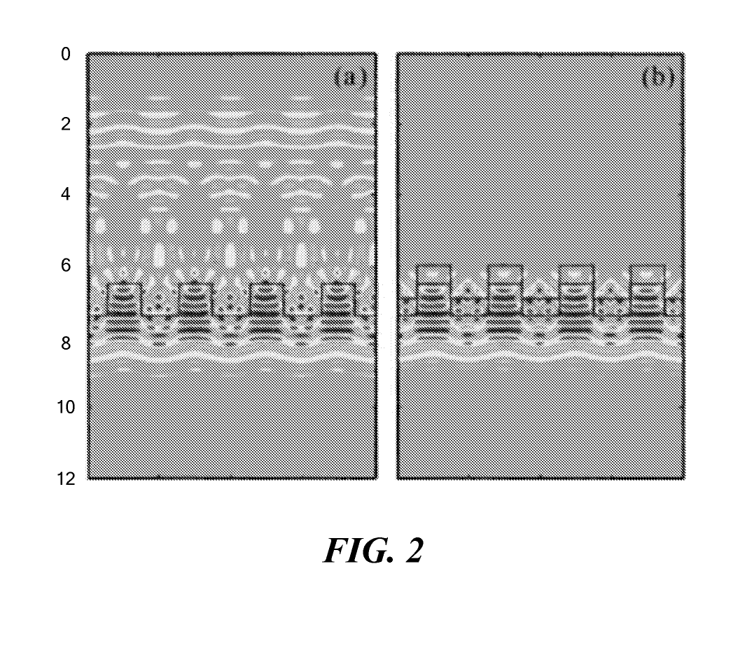

In this section, simulation examples are presented, demonstrating the enhanced performance binary and multi-level DOE when coated with nanostructured antireflection coatings in accordance with the present invention. For the first example, a binary transmission grating is considered. An antireflection structure is designed and optimized using the rigorous physical models described above and numerical simulation. FIG. 2(a) schematically depicts the electric field while propagating through a regular binary grating, with light is incident from the top. A significant amount of reflected light is observed. By way of contrast, FIG. 2(b) shows the behavior of an electric field for the same binary grating coated with an antireflection structure in accordance with the present invention. In this case, virtually no reflected field can be observed. The disclosed structure is therefore effective in suppressing reflection losses, while enhancing the ability of the optical element to transfer energy into the diffracted orders in the direction of transmission. The simulations of FIG. 2 were performed using the Finite-Difference Time-Domain (FDTD) method, as implemented in a software package available from Lumerical Solutions of Vancouver, Calif., as described in detail in Chang et al., Design and optimization of broadband wide-angle antireflection structures for binary diffractive optics, Optics Letters, vol. 35, pp. 907-09 (2010), which is incorporated herein by reference.

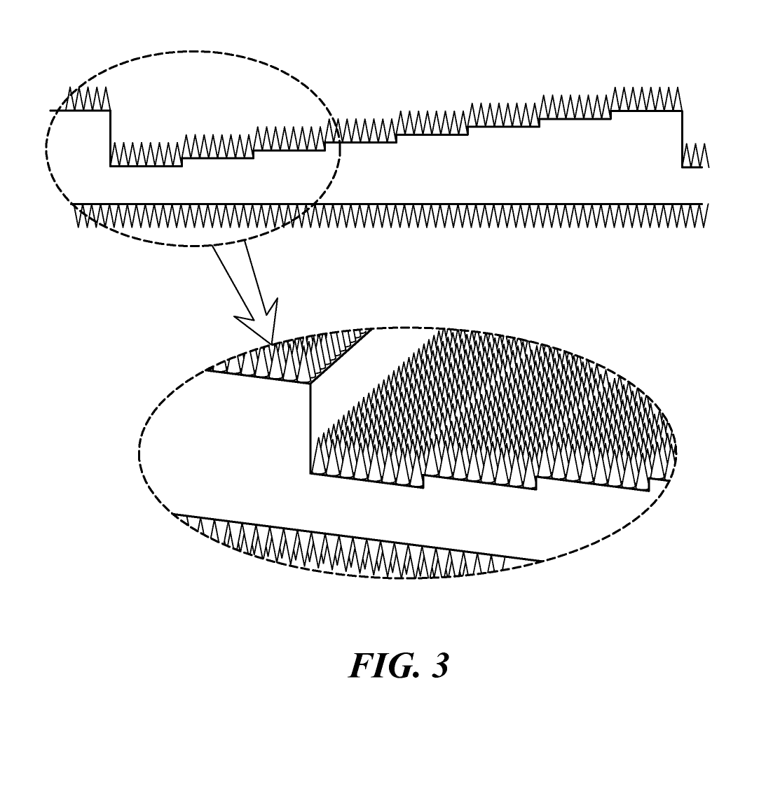

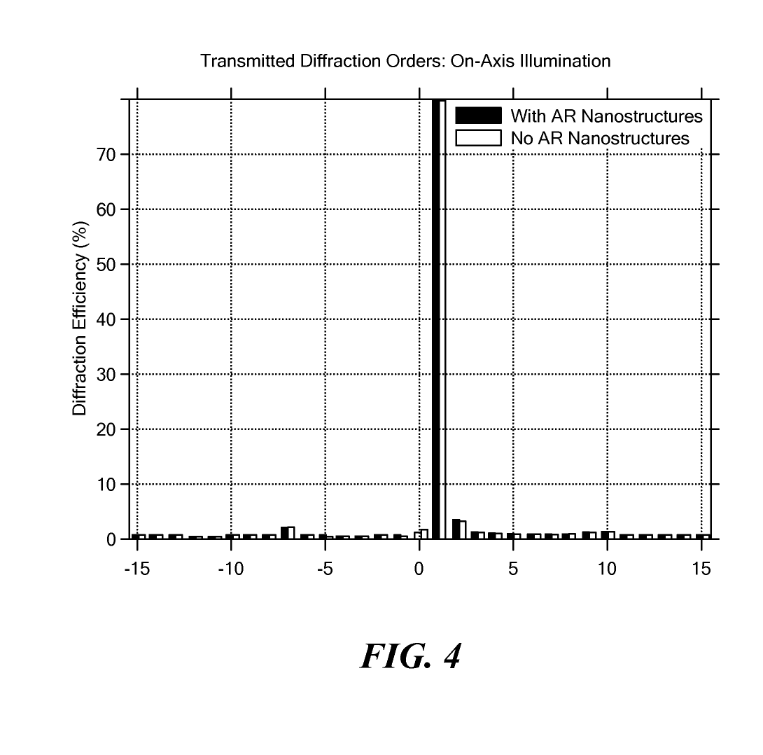

For a second example, the disclosed antireflection nanostructures are used to minimize the reflection losses on an 8-level quantized blazed grating (multi-level DOE), as illustrated in FIG. 3. In this case, the antireflection structures are coated on both sides (diffractive and flat sides), and the grating is designed to operate in transmission mode with an operation wavelength in the visible spectrum. The opposing flat surface of a transmissive grating may be referred to, herein, as the “opposite side.” FIG. 4 shows a comparison of the diffraction efficiencies for the same quantized blazed grating with and without the antireflection nanostructures. This simulation was also carried out using the FDTD method for the case of on-axis illumination. As can be seen, the overall transmission energy is increased with the implementation of the method of the present invention.

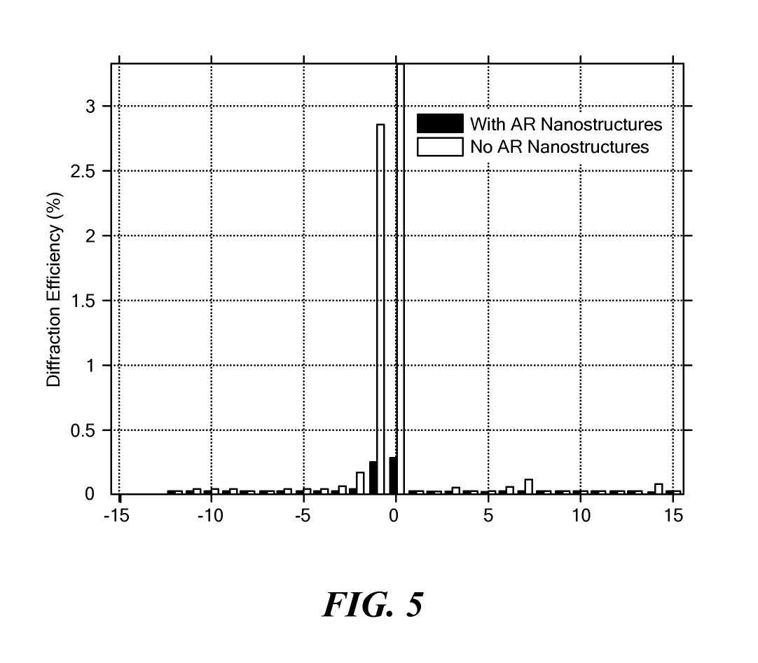

FIG. 5 shows a comparison of the diffraction efficiency of the reflected orders with and without subwavelength nano structures in accordance with an embodiment of the present invention. Reflection is undesirable, and it is apparent, again, that application of a method in accordance with an embodiment of the present invention significantly reduces the reflection losses.

While the simulations presented have demonstrated the enhanced performance for binary and blazed gratings, the disclosed method may readily be extended to all types of diffractive optical elements. An additional advantage of the method according to the present invention is that, in contrast to traditional antireflection coatings based on an interferometric effect used in the majority of commercially available optical elements, our antireflection coating is both broadband and has an increased acceptance angle.

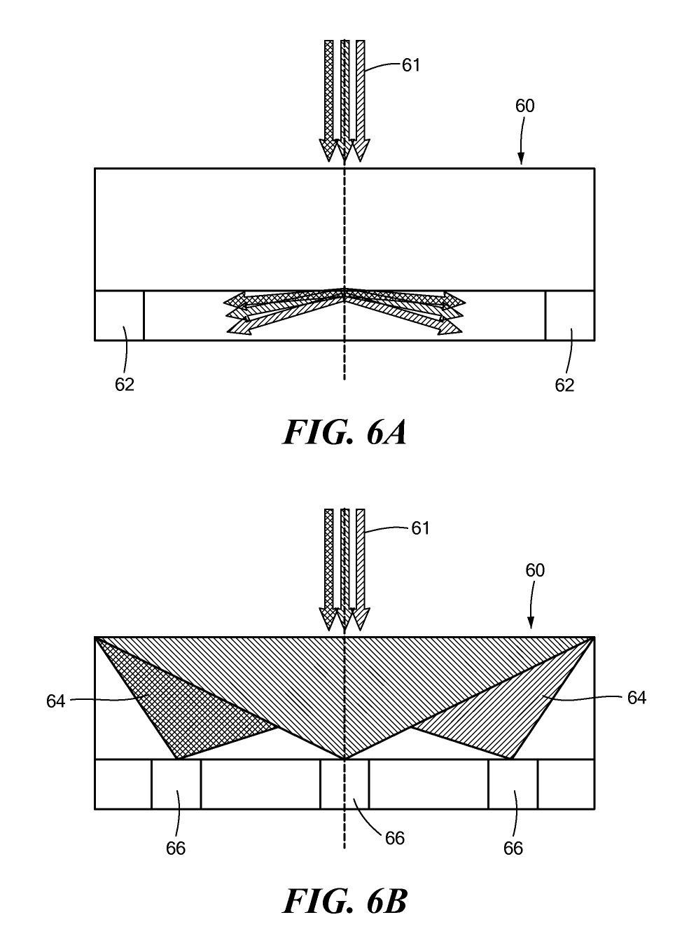

Examples of potential embodiments of the disclosed antireflection diffractive structure in an integrated solar concentrator are illustrated in FIGS. 6(a) and 6(b). In FIG. 6(a), spectrally broadband incident sunlight 61 is guided by diffractive element 60 horizontally to multiple-junction photovoltaic (PV) cells 62 on the walls of a solar device. In FIG. 6(b), diffractive element 60 focuses different wavelengths 64 of light to their corresponding PV cells 66, each PV cell having a spectrally matched energy band-gap for efficient energy conversion. In solar device applications, antireflection achieved in accordance with embodiments of the present invention are critical to efficient coupling of light to PV cells.

Methods disclosed in accordance with the present invention may advantageously improve the efficiency of any system that utilizes diffractive optics. The primary functionality for the disclosed method is to eliminate undesirable losses, and can be applied to any type of diffractive optics including but not limited to binary optics, blazed gratings, computer-generated holograms, multi-level diffractive optical elements, and the like. A primary application is the solar industry, especially for the manufacture of high-efficiency modules using diffractive optical elements as integrated solar concentrators. Embodiments of the present invention address the industry focus is on increasing module efficiency.

Other uses to which embodiments of the present invention may be advantageously applied include the semiconductor industry, for ablation and lithography, and telecommunication industry, where diffractive optics are widely used for free-space optical interconnects and coupling light in and out of integrated optical circuits.

The described embodiments of the invention are intended to be merely exemplary and numerous variations and modifications will be apparent to those skilled in the art. All such variations and modifications are intended to be within the scope of the present invention as defined in the appended claims.

What is claimed is:

1. A method for reducing reflection in a binary or multi-level diffractive optical element, the method comprising the steps of:
coating a non-planar diffractive surface of the diffractive optical element such that a plurality of nanostructures are formed on the non-planar diffractive surface; and
wherein parameters of the plurality of nanostructures are chosen for providing adiabatic refractive index matching at the optical interface between the non-planar diffractive surface and a surrounding medium subject to matching tangential fields at surface discontinuities.

2. The method as claimed in claim 1, wherein each nanostructure has a tapered shape in a direction towards the surrounding medium.

3. The method as claimed in claim 1 or 2, wherein the plurality of nanostructures have feature sizes smaller than the operating light wavelength.

4. The method as claimed in claim 1 or 2, wherein the plurality of nanostructures are formed in a periodic arrangement on the non-planar diffractive surface.

5. The method as claimed in claim 3, wherein the plurality of nanostructures are formed in a periodic arrangement on the non-planar diffractive surface.

6. The method as claimed in claim 1 or 2, wherein the plurality of nanostructures are formed in a random arrangement on the non-planar diffractive surface.

7. The method as claimed in claim 3, wherein the plurality of nanostructures are formed in a random arrangement on the non-planar diffractive surface.

8. The method as claimed in claim 5, wherein the plurality of nanostructures are formed in a random arrangement on the non-planar diffractive surface.

9. The method as claimed in claim 1 or 2, wherein nanostructures are further provided on a flat surface of the diffractive optical element opposite the non-planar diffractive surface.

10. A binary or multi-level diffractive optical element comprising:
a non-planar diffractive surface; and
a plurality of nanostructures formed on the diffractive surface;
wherein characteristics of the plurality of nano structures are chosen for providing adiabatic refractive index matching at the optical interface between the non-planar diffractive surface and a surrounding medium subject to matching tangential fields at surface discontinuities.
